(19) United States
(12) Patent Application Publication
(10) Pub. No.: US 2025/0238482 A1
(43) Pub. Date: Jul. 24, 2025

(54) HIGH-SPEED IN-MEMORY COMPUTING USING DYNAMICAL MEMORY

(71) Applicant: Rain Neuromorphics Inc., San Francisco, CA (US)

(72) Inventors: Mohammed Elneanaei Abdelmoneem Fouda, Alexandria, VA (US); Ramyad Hadidi, University Park, MD (US); Ross Pantone, Pacifica, CA (US)

(21) Appl. No.: 19/032,785

(22) Filed: Jan. 21, 2025

Related U.S. Application Data
(60) Provisional application No. 63/624,096, filed on Jan. 23, 2024.

(51) Int. Cl. G06F 17/16; G06F 9/30

(52) U.S. Cl. CPC G06F 17/16; G06F 9/30043; G06F 9/30047

(57) ABSTRACT

A hardware accelerator tile for performing vector matric multiplications (VMMs) using a set of parameters, and a method for loading the parameters to compute engines of the hardware accelerator tile for use in the VMMs. The hardware accelerator tile includes (i) a plurality of compute engines respectively including compute-in-memory (CIM) modules configured to perform, in parallel, VMMs on stored parameters, (ii) one or more stationary memory units coupled with the plurality of compute engines, and (iii) local memory coupled with the plurality of compute engines.

### CROSS REFERENCE TO OTHER APPLICATIONS

This application claims priority to U.S. Provisional Patent Application No. 63/624,096 entitled HIGH-SPEED IN-MEMORY COMPUTING USING DYNAMICAL MEMORY filed Jan. 23, 2024, which is incorporated herein by reference for all purposes.

### BACKGROUND OF THE INVENTION

Artificial intelligence (AI), or machine learning, utilizes learning networks loosely inspired by the brain in order to solve problems. Learning networks typically include layers of weights that weight signals (mimicking synapses) combined with activation layers that apply functions to the signals (mimicking neurons). The weight layers are typically interleaved with the activation layers. In the forward, or inference, path, an input signal is propagated through the learning network. In so doing, A weight layer can be considered to multiply input signals (the “activation” for that weight layer) by the weights stored therein and provide corresponding output signals. For example, the weights may be analog resistances or stored digital values that are multiplied by the input current, voltage or bit signals. The weight layer provides weighted input signals to the next activation layer, if any. Neurons in the activation layer operate on the weighted input signals by applying some activation function (e.g., ReLU or Softmax) and provide output signals corresponding to the statuses of the neurons. The output signals from the activation layer are provided as input signals (e.g., the activation) to the next weight layer, if any. This process may be repeated for the layers of the network, providing output signals that are the resultant of the inference. Learning networks are thus able to reduce complex problems to a set of weights and the applied activation functions. The structure of the network (e.g., the number of and connectivity between layers, the dimensionality of the layers, the type of activation function applied), including the value of the weights, is known as the model.

Although a learning network is capable of solving challenging problems, the computations involved in using such a network are often time consuming. For example, a learning network may use millions of parameters (e.g., weights), which are multiplied by the activations to utilize the learning network. Learning networks can leverage hardware, such as graphics processing units (GPUs) and/or AI accelerators, which perform operations usable in machine learning in parallel. Such tools can improve the speed and efficiency with which data-heavy and other tasks can be accomplished by the learning network. However, efficiency of such tools may still be less than desired, particularly for larger numbers of parameters. Further, the hardware tools may not be sufficiently flexible to adequately manage different types of parameters in the model. Consequently, improvements are desired.

### BRIEF DESCRIPTION OF THE DRAWINGS

Various embodiments of the invention are disclosed in the following detailed description and the accompanying drawings.

FIG. 1 is a diagram depicting an embodiment of a system usable in an AI accelerator and capable of performing on-chip learning.

FIG. 2 depicts an embodiment of a hardware compute engine usable in an AI accelerator and capable of performing local updates.

FIG. 3 depicts an embodiment of a portion of a compute-in-memory module usable in an AI accelerator.

FIG. 4 depicts an embodiment of a portion of a compute-in-memory module usable in an AI accelerator.

FIG. 5 is a diagram depicting an example of a system usable in an accelerator for a learning network.

FIG. 6A is a diagram depicting a system usable in an accelerator for a learning network according to various embodiments.

FIG. 6B is a diagram depicting a system usable in an accelerator for a learning network according to various embodiments

FIG. 7 is a diagram depicting a vertically integrated system usable in an accelerator for a learning network according to various embodiments.

FIG. 8 is a diagram depicting a vertically integrated system usable in an accelerator for a learning network according to various embodiments.

FIG. 9 is a diagram depicting a vertically integrated system usable in an accelerator for a learning network according to various embodiments.

FIG. 10 is a diagram depicting a system usable in an accelerator for a learning network according to various embodiments.

FIG. 11 is a diagram depicting a 2.5D integrated circuit (IC) system usable in an accelerator for a learning network according to various embodiments.

FIG. 12 is a diagram depicting a 3.5D integrated circuit (IC) system usable in an accelerator for a learning network according to various embodiments.

FIG. 13 is a flow diagram of a method for processing a workload by a system including a compute engine according to various embodiments.

FIG. 14 is a flow diagram of a method for loading parameters on a compute engine for processing a workload according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Although the following embodiments are described in some detail for purposes of clarity of understanding, the invention is not limited to the details provided. There are many alternative ways of implementing the invention. The disclosed embodiments are illustrative and not restrictive.

Various embodiments described herein implement techniques that may improve efficiency in applications such as large language models (LLMs).

In some embodiments, a system having compute engines (CEs) is described. A CE includes at least one compute-in-memory (CIM) module. The system also includes local memory coupled with the CEs and a general-purpose processor coupled with the CEs. In some embodiments, the local memory is dynamic random access memory (DRAM). Various other types of local memory may be implemented, such as eDRAM, DDR, HBM, etc. In some embodiments, the local memory (e.g., DRAM) is directly connected to the CEs. In some embodiments, the local memory (e.g., DRAM) is connected to the CEs via stationary memory, such as SRAM module(s).

The stationary memory can be used to cache information for use at the CEs. For example, data (e.g., weights) are loaded to the stationary memory from the local memory (e.g., the DRAM) and cached at the stationary memory until the data is to be used by the CEs. The local memory (e.g., the DRAM) and/or the stationary memory (e.g., the SRAM) may be implemented in the architecture as a stacked architecture. For example, one or both of the local memory and the stationary memory may be in a separate layer (e.g., a memory layer or a stationary memory layer) that is distinct from a compute layer comprising the compute engines.

In some embodiments, the system may also be or be part of a tile that is integrated into a system-on-a-chip (SoC) or network-on-a-chip (NoC) with other tile(s). Thus, the system may have a 2.5D or 3.5D architecture.

Large Language Models (LLMs) sizes have been increasing exponentially of the last few years, reaching over 1 trillion parameters for GPT4. Such large models generally rely on the use of a large number of GPUs for the underlying computations. Reducing the data movement and increasing the on-chip memory leads to a significant speed-up in performance and a significant reduction in energy consumption. Meanwhile, development of both 3D integration and chiplet technologies has continued and is at the maturation stage of incorporation in products. These technologies have shown significant gains in energy, latency, and area. Although these technology paradigms could lead to accelerations of AI workloads, there is a desire for further improvements.

Static random access memory (SRAM) memory density is low as compared to other memory technologies such as dynamic random access memory (DRAM), double data rate (DDR), and high bandwidth memory (HBM), etc. . . . In addition, SRAM scaling is saturating as a result of its inherent physical limitations. In contrast, other memories such as DRAM offer high-density memory solutions that can be used in AI accelerators. Recent graphics processing unit (GPU) architectures have implemented on-chip memory to address the memory issue. However, the use of on-chip memory, such as DRAM, is still insufficient to accelerate models such as GPT4, where the main DRAM is relied upon to store the main model. In addition, increasing the on-chip GPU memory greatly increases the device cost. Conventional SRAM-based compute-in-memory (CIM) architectures generally rely on stationary tensors, especially weights, to achieve orders of magnitude gains in acceleration. However, due to the limited density of SRAMs, such architectures are not scalable and require weight swapping, thereby reducing the gains of CIM.

Accordingly, techniques that can handle applications such as LLMs (e.g., which use a large number of parameters) are desired.

Various embodiments provide an AI accelerator, for example, a machine learning accelerator. The accelerator includes compute engines (CEs) comprising CIM, and local memory configured for low latency and high bandwidth. Because of the inherent speed limitations (e.g., the slowness) of local memory such as DRAM, DDRx, eDRAM, SDRAM, and HBM, of DRAM, various embodiments implement a caching between the local memory and the compute engines (e.g., the CIM). In some embodiments, the architecture further includes a stationary memory unit that is configured to function as a cache for the compute engines. Weights can be pre-loaded from the local memory (e.g., the DRAM, etc.) and cached at the stationary memory unit, and then transferred (e.g., at a higher transfer speed) from the stationary memory unit to the compute engine when the compute engine is to use the weights. In such an architecture, a stationary memory, for example SRAM, may be used as a cache between the compute engines (and thus the CIMs) and the local memory (e.g. DRAM, SDRAM, embedded DRAM (eDRAM), HBM, and DDRx, etc.) to increase the speed of the load the data and continue processing.

Various embodiments provide a hardware accelerator tile for performing vector matric multiplications (VMMs) using a set of parameters (e.g., comprising a set of weights), and/or a method for loading the parameters to compute engines of the hardware accelerator tile for use in the VMMs. The hardware accelerator tile includes (i) a plurality of compute engines respectively including CIM modules configured to perform, in parallel, VMMs on stored parameters, (ii) one or more stationary memory units coupled with the plurality of compute engines, and (iii) local memory coupled with the plurality of compute engines.

Various embodiments provide a system comprising: (i) a plurality of compute engines, each of the plurality of compute engines including at least one CIM module, (ii) local memory coupled with the plurality of compute engines, and (iii) a general-purpose processor coupled with the plurality of compute engines. The local memory may include dynamic random access memory (DRAM). In some embodiments, the DRAM has a stacked architecture. The system may be comprised in a tile integrated into a system-on-a-chip (SoC) having a plurality of tiles in a 2.5D or 3.5D architecture.

In some embodiments, the local memory may further include a plurality of SRAM modules coupled between the DRAM and the plurality of compute engines. In some embodiments, at least one of the DRAM and the plurality of SRAM modules has a stacked architecture. The plurality of SRAM modules can be directly connected with the DRAM and the plurality of compute engines.

In some embodiments, the hardware accelerator tile comprises a plurality of layers that are vertically integrated. As an example, the plurality of layers comprises (i) a compute layer comprising the plurality of compute engines, and (ii) a memory layer comprising the memory storing the set of parameters. The plurality of layers may comprise a stationary memory unit layer comprising one or more stationary memory units. The stationary memory unit layer may be disposed between the computer layer and the memory layer.

According to various embodiments, a machine learning system is provided. The machine learning system comprises (a) at least one processor, and (b) a plurality of tiles coupled with the at least one processor, each of the plurality of tiles including: (i) a plurality of compute engines respectively including compute-in-memory (CIM) modules configured to perform, in parallel, vector matrix multiplications (VMMs) on stored parameters, (ii) one or more stationary memory units coupled with the plurality of compute engines, and (iii) local memory coupled with the plurality of compute engines. In some embodiments, the machine learning system comprises a memory that stores a set of parameters to be loaded to the plurality of compute engines.

According to various embodiments, a method for loading parameters to a compute engine in a hardware accelerator tile or chip. The method includes (a) storing a set of parameters to be used in connection with VMMs, (b) loading a subset of the parameters to a particular stationary memory unit, and (c) loading the subset of parameters from the particular stationary memory unit to a particular compute engine. The particular compute engine and the particular stationary memory unit are comprised in a hardware accelerator tile comprising (i) a plurality of compute engines, (ii) one or more stationary memory units coupled with the plurality of compute engines, and (iii) local memory coupled with the plurality of compute engines. In some embodiments, the hardware accelerator tile comprises a memory that stores a set of parameters to be loaded to the plurality of compute engines.

Data is loadable to the plurality of compute engines from the local memory or from the stationary memory units. The data may be loadable from the local memory or the stationary memory units comprises the parameters used in connection with the VMMs.

The local memory and/or a particular stationary memory unit of the one or more stationary memory units comprises an SRAM memory.

In some embodiments, a set of parameters is loaded to a particular compute engine directly from a corresponding stationary memory unit. The particular compute engine may be comprised in the plurality of compute engines. The corresponding stationary memory unit may be comprised in the one or more stationary memory units. The corresponding stationary memory unit may be connected directly to the particular compute engine.

In some embodiments, data is provided from a memory to at least one stationary memory unit of the one or more stationary memory units. A time for loading the data from the memory to the at least one stationary memory unit is longer than a time for loading the data from the at least one stationary memory unit to the corresponding at least one compute engine. The memory is a dynamic random-access memory (DRAM), a double data rate (DDR), or a high bandwidth memory (HBM), etc.

In some embodiments, the one or more stationary memory units are used as a cache for a set of parameters that is to be loaded to the plurality of compute engines.

Using the techniques described herein, improved efficiency, reduced power consumption, faster data movement, and/or higher density is achieved. For example, on-chip memory density parameters may allow for a 6000× larger model on-chip without the need for parameter swapping between external memory. The expected energy gain in some embodiments due to less data movement is more than 20× and more than 100× when local computation is included. For some embodiments, the expected speedup is greater than 10× due to reducing higher bandwidth memory or eliminating the need for data movement (including weights and activations) off the chip.

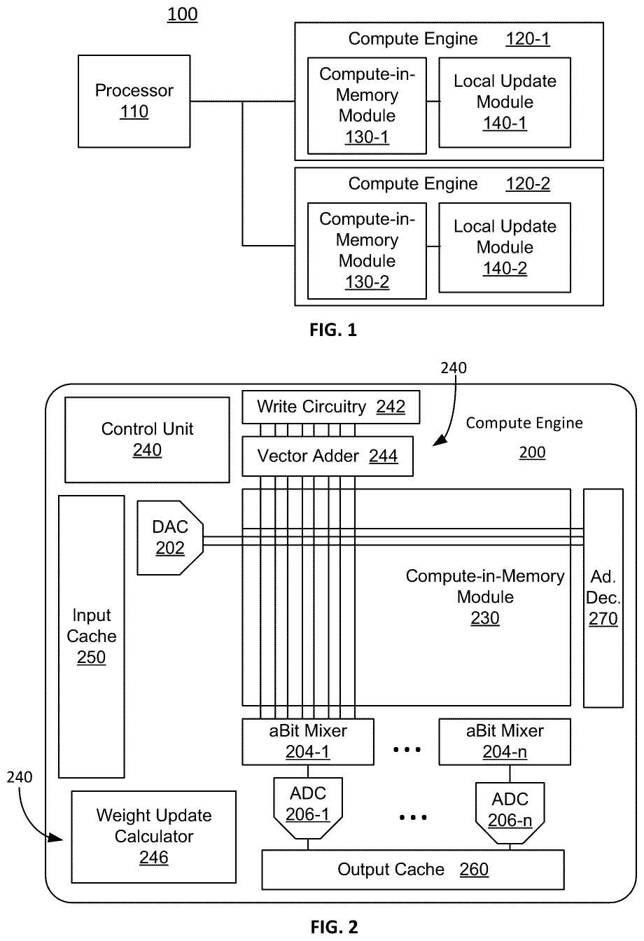

FIG. 1 is a diagram depicting an embodiment of a system usable in an AI accelerator and capable of performing on-chip learning. System 100 may be an artificial intelligence (AI) accelerator that can be deployed for using a model (not explicitly depicted) and for allowing for on-chip training of the model (otherwise known as on-chip learning). System 100 may thus be implemented as a single integrated circuit. System 100 includes processor 110 and compute engines 120-1 and 120-2 (collectively or generically compute engines 120). Other components, for example a cache or another additional memory, mechanism(s) for applying activation functions, and/or other modules, may be present in system 100. Although a single processor 110 is shown, in some embodiments multiple processors may be used. In some embodiments, processor 110 is a reduced instruction set computer (RISC) processor. In other embodiments, different and/or additional processor(s) may be used. Processor 110 implements instruction set(s) used in controlling compute engines 120.

Compute engines 120 are configured to perform, efficiently and in parallel, tasks used in training and/or using a model. Although two compute engines 120 are shown, another number (generally more) may be present. Compute engines 120 are coupled with and receive commands from processor 110. Compute engines 120-1 and 120-2 include CIM modules 130-1 and 130-2 (collectively or generically CIM module 130) and local update (LU) modules 140-1 and 140-3 (collectively or generically LU module 140). Although one CIM module 130 and one LU module 140 is shown in each compute engine 120, a compute engine may include another number of CIM modules 130 and/or another number of LU modules 140. For example, a compute engine might include three CIM modules 130 and one LU module 140, one CIM module 130 and two LU modules 140, or two CIM modules 130 and two LU modules 140.

CIM module 130 is a hardware module that stores data and performs operations. In some embodiments, CIM module 130 stores weights for the model. CIM module 130 also performs operations using the weights. More specifically, CIM module 130 performs vector-matrix multiplications, where the vector may be an input vector provided using processor 110 and the matrix may be weights (e.g., data/parameters) stored by CIM module 130. Thus, CIM module 130 may be considered to include a memory (e.g., that stores the weights) and compute hardware (e.g., that performs the vector-matrix multiplication of the stored weights). In some embodiments, the vector may be a matrix (e.g., an n×m vector where n>1 and m>1). For example, CIM module 130 may include an analog static random access memory (SRAM) having multiple SRAM cells and configured to provide output(s) (e.g., voltage(s)) corresponding to the data (weight/parameter) stored in each cell of the SRAM multiplied by a corresponding element of the input vector. In some embodiments, CIM module 130 may include a digital static SRAM having multiple SRAM cells and configured to provide output(s) corresponding to the data (weight/parameter) stored in each cell of the digital SRAM multiplied by a corresponding element of the input vector. In some embodiments, CIM module 130 may include an analog resistive random access memory (RAM) configured to provide output (e.g., voltage(s)) corresponding to the impedance of each cell multiplied by the corresponding element of the input vector. Other configurations of CIM module 230 are possible. Each CIM module 130 thus stores weights corresponding to a matrix in its cells and is configured to perform a vector-matrix multiplication of the matrix with an input vector.

In order to facilitate on-chip learning, LU modules 140 are provided. LU modules 140-1 and 140-2 are coupled with the corresponding CIM modules 130-1 and 130-2, respectively. LU modules 140 are used to update the weights (or other data) stored in CIM modules 130. LU modules 140 are considered local because LU modules 140 are in proximity and CIM modules 130. For example, LU modules 140 may reside on the same integrated circuit as CIM modules 130. In some embodiments LU modules 140-1 and 140-2 for a particular compute engine reside in the same integrated circuit as the CIM modules 130-1 and 130-2, respectively, for the compute engine 120-1 and 120-2. In some embodiments, LU module 140 is considered local because it is fabricated on the same substrate (e.g., the same silicon wafer) as the corresponding CIM module 130. In some embodiments, LU modules 140 are also used in determining the weight updates. In other embodiments, a separate component may calculate the weight updates. For example, in addition to or in lieu of LU modules 140, the weight updates may be determined by processor 110, in software by other processor(s) not part of system 100 (not shown), by other hardware that is part of system 100, by other hardware outside of system 100, and/or some combination thereof.

System 100 may thus be considered to form some or all of a learning network. Such a learning network typically includes layers of weights (corresponding to synapses) interleaved with activation layers (corresponding to neurons). In operation, a layer of weights receives an input signal and outputs a weighted signal that corresponds to a vector-matrix multiplication of the input signal with the weights. An activation layer receives the weighted signal from the adjacent layer of weights and applies the activation function, such as a ReLU or sigmoid. The output of the activation layer may be provided to another weight layer or an output of the system. One or more of the CIM modules 130 corresponds to a layer of weights. For example, if all of the weights in a layer can be stored in the cells of CIM module 130, then system 100 may correspond to two layers of weights. In such a case, the input vector may be provided (e.g., from a cache, from a source not shown as part of system 100, or from another source) to CIM module 130-1. CIM module 130-1 performs a vector-matrix multiplication of the input vector with the weights stored in its cells. The weighted output may be provided to component(s) corresponding to an activation layer. For example, processor 110 may apply the activation function and/or other component(s) (not shown) may be used. The output of the activation layer may be provided to CIM module 130-2. CIM module 130-2 performs a vector-matrix multiplication of the input vector (the activation layer) with the weights stored in its cells. The output may be provided to another activation layer, such as processor 110 and/or other component(s) (not shown). If all of the weights in a weight layer cannot be stored in a single CIM module 130, then CIM modules 130 may include only a portion of the weights in a weight layer. In such embodiments, portion(s) of the same input vector may be provided to each CIM module 130. The output of CIM modules 130 is provided to an activation layer. Thus, inferences may be performed using system 100. During training of the learning network, updates to the weights in the weight layer(s) are determined. Thus, the weights in (e.g., parameters stored in cells of) CIM modules 130 are updated using LU modules 140.

Using system 100, efficiency and performance of a learning network may be improved. Use of CIM modules 130 may dramatically reduce the time to perform the vector-matrix multiplication that provides the weighted signal. Thus, performing inference(s) using system 100 may require less time and power. This may improve efficiency of training and use of the model. LU modules 140 allow for local updates to the weights in CIM modules 130. This may reduce the data movement that may otherwise be required for weight updates. Consequently, the time taken for training may be greatly reduced. In some embodiments, the time taken for a weight update using LU modules 140 may be an order of magnitude less (e.g., require one-tenth the time) than if updates are not performed locally. Efficiency and performance of a learning network provided using system 100 may be increased.

FIG. 2 depicts an embodiment of a hardware compute engine usable in an AI accelerator and capable of performing local updates. Compute engine 200 may be a hardware compute engine analogous to compute engines 120. Compute engine 200 thus includes CIM module 230 and LU module 240 analogous to CIM modules 130 and LU modules 140, respectively. Compute engine 200 also includes analog bit mixer (aBit mixer) 204-1 through 204-n (generically or collectively 204), analog to digital converter(s) (ADC(s)) 206-1 through 206-n (generically or collectively 206), input cache 250, output cache 260, and address decoder 270. Although particular numbers of components 202, 204, 206, 230, 240, 242, 244, 246, 260, and 270 are shown, another number of one or more components 202, 204, 206, 230, 240, 242, 244, 246, 260, and 270 may be present.

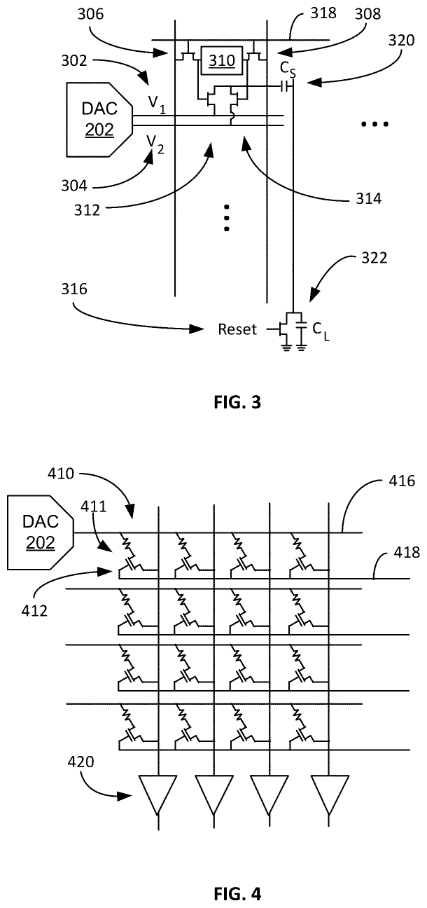

CIM module 230 is a hardware module that stores data corresponding to weights and performs vector-matrix multiplications (e.g., VMMs of the matrix with an input vector). The vector is an input vector provided to CIM module 230 (e.g., via input cache 250) and the matrix includes the weights stored by CIM module 230. In some embodiments, the vector may be a matrix. Examples of embodiments CIM modules that may be used in CIM module 230 are depicted in FIGS. 3 and 4.

In some embodiments, compute engine 200 stores positive weights in CIM module 230. However, the use of both positive and negative weights may be desired for some models and/or some applications. In such cases, bipolar weights (e.g., having range −S through +S) are mapped to a positive range (e.g., 0 through S). For example, a matrix of bipolar weights, W, may be mapped to a positive weight matrix Wp such that: Wx=(Wp−SJ/2)(2x)=2Wpx−SSixi. where J is a matrix of all ones having the same size as W and S is the maximum value of the weight (e.g., 2N−1−1 for an N-bit weight). For simplicity, compute engine 200 is generally discussed in the context of CIM module 230 being an analog SRAM CIM module.

FIG. 3 depicts an embodiment of a portion of a compute-in-memory module usable in an AI accelerator, which may be usable for CIM module 230. Also shown is DAC 202 of compute engine 200. For clarity, only one SRAM cell 310 is shown. However, multiple SRAM cells 310 may be present. For example, multiple SRAM cells 310 may be arranged in a rectangular array. An SRAM cell 310 may store a weight or a part of the weight. The CIM module shown includes lines 302, 304, and 318, transistors 306, 308, 312, 314, and 316, capacitors 320 (C_{S}) and 322 (C_{L}). In the embodiment shown in FIG. 3, DAC 202 converts a digital input voltage to differential voltages, V₁ and V₂, with zero reference. These voltages are coupled to each cell within the row. DAC 202 is thus used to temporal code differentially. Lines 302 and 304 carry voltages V₁ and V₂, respectively, from DAC 202. Line 318 is coupled with address decoder 270 (not shown in FIG. 3) and used to select SRAM cell 310 (and, in the embodiment shown, the entire row including SRAM cell 310), via transistors 306 and 308.

In operation, voltages of capacitors 320 and 322 are set to zero, for example via a reset provided to transistor 316. DAC 202 provides the differential voltages on lines 302 and 304, and the address decoder (not shown in FIG. 3) selects the row of SRAM cell 310 via line 318. Transistor 312 passes input voltage V₁ if SRAM cell 310 stores a logical 1, while transistor 314 passes input voltage V₂ if SRAM cell 310 stores a zero. Consequently, capacitor 320 is provided with the appropriate voltage based on the contents of SRAM cell 310. Capacitor 320 is in series with capacitor 322. Thus, capacitors 320 and 322 act as capacitive voltage divider. Each row in the column of SRAM cell 310 contributes to the total voltage corresponding to the voltage passed, the capacitance, C_{S}, of capacitor 320, and the capacitance, C_{L}, of capacitor 322. Each row contributes a corresponding voltage to the capacitor 322. The output voltage is measured across capacitor 322. In some embodiments, this voltage is passed to the corresponding aBit mixer 204 for the column. In some embodiments, capacitors 320 and 322 may be replaced by transistors to act as resistors, creating a resistive voltage divider instead of the capacitive voltage divider. Thus, using the configuration depicted in FIG. 3, CIM module 230 may perform a vector-matrix multiplication using data stored in SRAM cells 310.

FIG. 4 depicts an embodiment of a portion of a compute-in-memory module usable in an AI accelerator, which may be usable for CIM module 230. Also shown is DAC 202 of compute engine 200. For clarity, only one resistive cell 410 is labeled. However, multiple cells 410 are present and arranged in a rectangular array (e.g., a crossbar array in the embodiment shown). Also labeled are corresponding lines 416 and 418 and current-to-voltage sensing circuit 420. Each resistive cell includes a programmable impedance 411 and a selection transistor 412 coupled with line 418. Bit slicing may be used to realize high weight precision with multi-level cell devices.

Examples of compute engines, their components, and systems or tiles comprising the compute engines which may be implemented in various embodiments are further described in U.S. patent application Ser. No. 18/384,774, the entirety of which is hereby incorporated herein for all purposes.

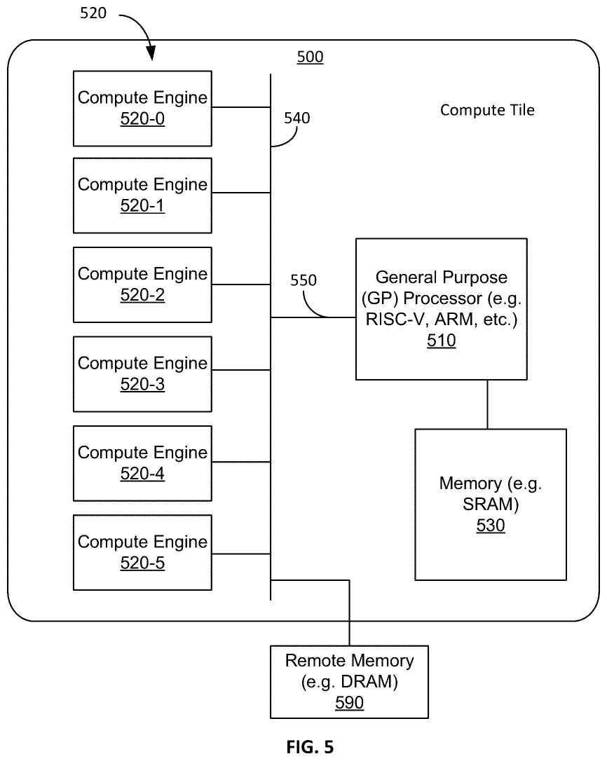

FIG. 5 is a diagram depicting an example of a system usable in an accelerator for a learning network. The system is a compute tile 500 and may be considered to be an artificial intelligence (AI) accelerator having an efficient architecture. Compute tile (or simply “tile”) 500 may be implemented as a single integrated circuit. Compute tile 500 includes a general purpose (GP) processor 510 and compute engines 520-0 through 520-5 (collectively or generically compute engines 520). Although five compute engines 520 are shown, in other embodiments another number may be included. GP processor 510 is shown as being coupled with compute engines 520 via compute bus 540 (or other connector), and bus 550. In other embodiments, GP processor 510 may be connected with compute engines 520 in another manner. In some embodiments, compute tile 500 may include on-tile memory 530. In other embodiments, memory 530 may be omitted. Other components, for example a cache or another additional memory, module(s) for applying activation functions, modules for moving data, and/or other modules, may be present in compute tile 500 in some embodiments.

GP processor 510 is a reduced instruction set computer (RISC) processor. For example, GP processor 510 may be a RISC-V processor or ARM processor. In other embodiments, different and/or additional general purpose processor(s) may be used. The GP processor 510 provides control instructions and data to the compute engines 520. GP processor 510 implements instruction set(s) used in controlling compute engines 520. GP processor 510 provides the commands to compute engines 520 and controls data movement to and/or from compute engines 520. GP processor 510 may thus function as part of a control plane for (e.g., providing commands and being part of the data path) compute engines 520 and compute tile 500.

In some embodiments, data is moved from memory 530 or another source to compute engine(s) 520 through GP processor 510. Data may be sent from memory 530 to internal memory of GP processor 510, and then to the appropriate compute engine(s) 520 via buses 540 and 550. For example, data from memory 530 may be provided to a vector register file (not shown) of GP processor 510 and then provided from GP processor 510 to the appropriate compute engine(s) 520. Once compute engines 520 have performed their functions, the output is provided to GP processor 510. Similarly, data may be moved from compute engines 520 to memory 530 or another destination via GP processor 510. Thus, GP processor 510 may be part of both the control plane and data plane for compute tile 500.

GP processor 510 may also perform other functions. GP processor 510 may apply activation function(s) to data. For example, an activation function (e.g., a ReLu, Tanh, and/or SoftMax) may be applied to the output of compute engine(s) 520. Thus, GP processor 510 may perform nonlinear operations. GP processor 510 may also perform linear functions and/or other operations. However, GP processor 510 is still desired to have reduced functionality as compared to, for example, a graphics processing unit (GPU) or central processing unit (CPU) of a computer system with which compute tile 500 might be used.

Compute engines 520 are configured to perform, efficiently and in parallel, tasks that may be part of using (e.g., performing inferences) and/or training (e.g., performing inferences and/or updating weights) a model. Compute engines 520 are coupled with and receive commands and, in at least some embodiments, data from GP processor 510. Compute engines 520 are modules which perform vector-matrix multiplications (VMMs) in parallel. Thus, compute engines 520 may perform linear operations. Each compute engine 520 includes a CIM hardware module (not specifically shown in FIG. 5). The CIM hardware module stores weights corresponding to a matrix and is configured to perform a VMM in parallel for the matrix. Compute engines 520 may also include LU module(s) (not specifically shown in FIG. 5). Such LU module(s) allow compute engines 520 to update weights stored in the CIM.

The CIM module is a hardware module that stores data and performs operations. In some embodiments, CIM module stores weights for the model. As such, the CIM module determines the maximum size of the model that can be handled by compute tile 500 (e.g., the maximum number of parameters, or weights). The CIM module stores the weights (or other data) in cells that are fully addressable. The CIM module also performs operations using the weights. More specifically, the CIM module performs VMMs, where the vector may be an input vector (e.g., an activation) provided using GP processor 510 and the matrix may be weights (e.g., data/parameters) stored by the CIM module. The CIM module may be considered to include a memory (e.g., that stores the weights) and compute hardware (e.g., that performs the vector-matrix multiplication of the stored weights). In some embodiments, the vector may be a matrix. The CIM module may include an analog SRAM having multiple SRAM cells and configured to provide output(s) (e.g., voltage(s)) corresponding to the data (weight/parameter) stored in each cell of the SRAM multiplied by a corresponding element of the input vector. In some embodiments, the CIM module may include a digital SRAM having multiple SRAM cells and configured to provide output(s) corresponding to the data (weight/parameter) stored in each cell of the digital SRAM multiplied by a corresponding element of the input vector. Other configurations of CIM modules are possible. Each CIM module thus stores weights corresponding to a matrix in its cells and is configured to perform a vector-matrix multiplication of the matrix with an input vector. In some embodiments, the CIM module of a compute engine 520 may be repurposed as memory if the compute engine utilization falls below a particular threshold (e.g., 70%-80%). For example, the CIM might store duplicate weights or vectors (e.g., activations) in such embodiments.

In order to facilitate on-chip learning, LU modules (not shown) may also be provided in compute engines 520. LU modules are coupled with the corresponding CIM modules. LU modules are used to update the weights (or other data) stored in the CIM modules. LU modules are considered local because LU modules are in proximity to CIM modules. For example, LU module(s) for a particular compute engine 520 may reside in the same integrated circuit as the CIM module(s) for compute engine 520. In some embodiments, the LU module is considered local because it is fabricated on the same substrate (e.g., the same silicon wafer) as the corresponding CIM module. In some embodiments, LU modules are also used in determining the weight updates. In other embodiments, a separate component may calculate the weight updates. For example, in addition to or in lieu of LU modules, the weight updates may be determined by GP processor 510, in software by other processor(s) not part of compute tile 500, by other hardware that is part of compute tile 500, by other hardware outside of compute tile 500, and/or some combination thereof.

Memory 530 may be or include a static random access memory (SRAM) and/or some other type of memory. Memory 530 is shown as coupled with GP processor 510. Stated differently, data movement between memory 530 and compute engines 520 may take place via GP processor 510. In some embodiments, memory 530 may be coupled to compute bus 540 (e.g., to compute engines 520). Memory 530 may store activations (e.g., input vectors provided to compute tile 500 and the resultant of activation functions applied to the output of compute engines 520). Memory 530 may also store weights. For example, memory 530 may contain a backup copy of the weights or different weights if the weights stored in compute engines 520 are desired to be changed. In some embodiments, memory 530 is organized into banks of cells (e.g., banks of SRAM cells). In such embodiments, specific banks of memory 530 may service specific one(s) of compute engines 520. In other embodiments, banks of memory 530 may service any compute engine 520.

In operation, an input vector is provided to one or more of compute engines 520 by GP processor 510. The input vector is desired to be multiplied by the weights, which may have been previously stored in compute engine(s) 520. An input vector may be provided to multiple compute engines 520 if the weight matrix and/or input vector have too many elements for a single compute engine. In some such embodiments, a portion of the input vector is provided to each of the multiple compute engines 520 (each of which stores a portion of the weights). In some embodiments, the input vector is provided from memory 530 to GP processor 510 and from GP processor 510 to compute engine(s) 520. GP processor 510 also instructs compute engine(s) 520 to perform a VMM. Compute engine(s) 520 perform a VMM between the input vector and the matrix of weights to provide an output. The VMM is performed in parallel for the elements of the input vector. The output of compute engine(s) 520 may be considered an output vector. The output is provided by compute engine(s) 520 to GP processor 510. For example, the output may be stored in a vector register file of GP processor 510. GP processor 510 may also store the output (e.g., in memory 530) and/or may provide the output to another component off-tile. GP processor 510 may apply a function (e.g., an activation function) to the output. The results of the activation function applied to the output of compute engines 520 may be stored in GP processor 510 (e.g., in a buffer or the vector register file). GP processor 510 may also store the results in memory 530 or off-tile. GP processor 510 may provide the results as an input vector to other compute engine(s) 520 to apply a different set of weights to the results where another set of weights are stored in other compute engine(s) 520. Thus, one or more inferences with one or more distinct sets of weights may be performed. In some embodiments, training may also be performed by compute tile 500. In some such embodiments, GP processor 510 or another component (such as a host) may determine the desired update for the weights. In some embodiments, LU module (not shown) of compute engines 520 may be used to determine and apply the updates to the weights.

Also shown in FIG. 5 is remote memory 590. For example, remote memory 590 may include or be DRAM memory. Remote memory 590 may be used for long term storage. For example, input activations for training, target outputs for training, and/or other information may be stored in DRAM (e.g., remote memory 590). This information may be loaded into compute tile 500 as desired. For example, if compute tile 500 includes insufficient memory for performing a training iteration as part of a method for processing workloads, activations and/or other data may be temporarily stored and loaded from remote memory 590 (e.g., DRAM) during a training iteration.

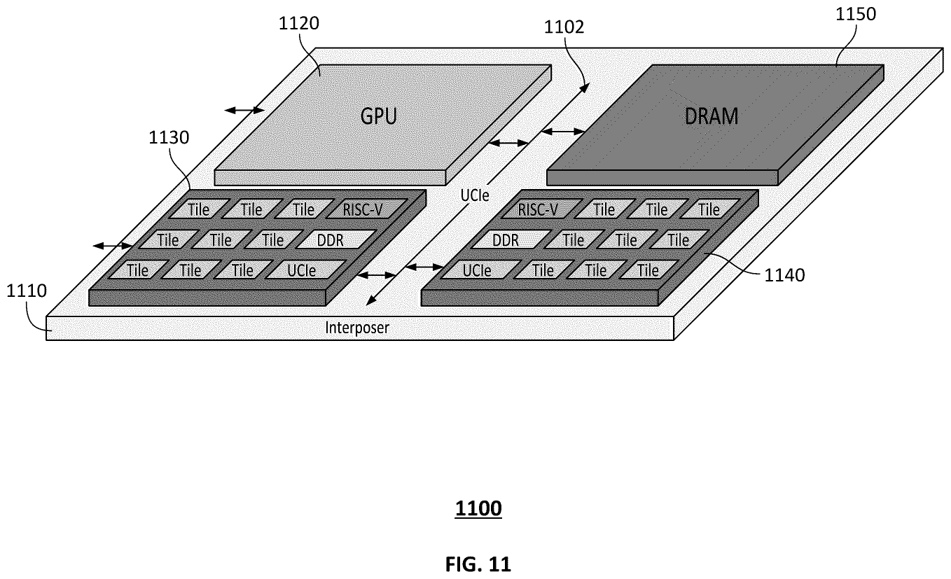

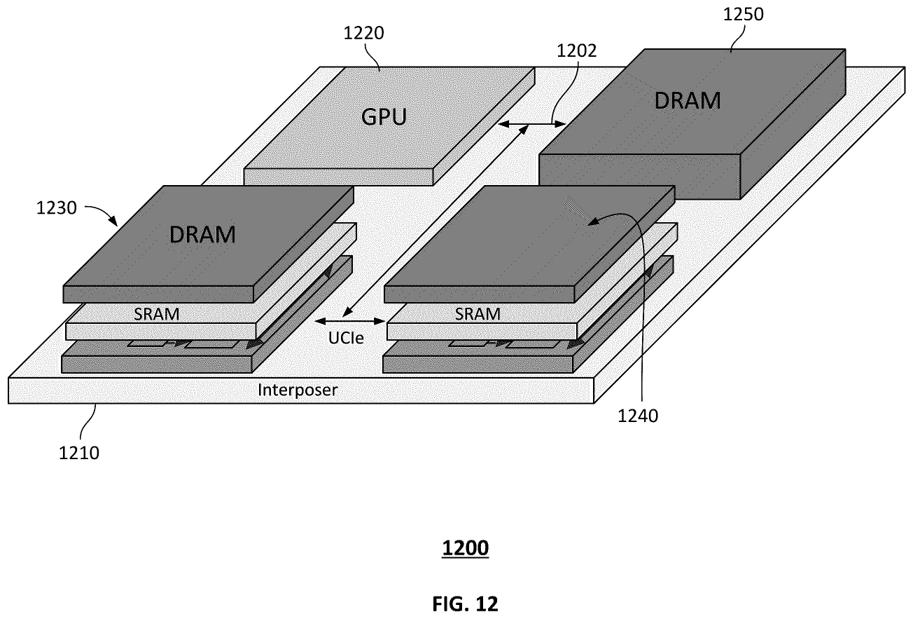

Thus, compute tile 500 includes two compute blocks, GP processor 510 and compute engines 520, which work together. GP processor 510 may perform nonlinear operations (e.g., activation functions) and compute engines perform 520 may perform linear operations (e.g., VMMs). GP processor 510 is in the control and data planes for compute engines 520. GP processor 510 and compute engines 520 are, therefore, tightly coupled. Consequently, data may be moved more efficiently within compute tile 500. Operations, such as VMMs and the application of activation functions to the output of compute engines 520, may be more efficiently performed. Further, a special purpose controller need not be designed and fabricated for compute tile 500. Instead, GP processor 510 is used. As a result, compute tile 500 may be more flexible and more readily designed and fabricated. For example, the activation applied by GP processor 510 may be updated by updating GP processor 510. A new special purpose controller need not be provided. Consequently, functions for machine learning may be more efficiently and readily performed. In addition, compute tile 500 includes on-tile memory 530. Use of on-tile memory, for example as a scratchpad memory, allows for a high degree of independence of compute tile 500 from other components (e.g., other tiles). Thus, multiple compute tiles 500 may more readily work in parallel (e.g., as shown in FIGS. 11 and 12). Consequently, efficiency of learning may be enhanced.

Examples of compute tiles, components of compute tiles, systems comprising compute tiles, and use of compute tiles in connection with processing a workload (e.g., performing operations such as VMMs) are further described in U.S. patent application Ser. No. 18/750,830, the entirety of which is hereby incorporated herein for all purposes.

The compute engines depicted in FIGS. 1-2 and 5 may be used to efficiently perform tasks in parallel, such as vector matrix multiplications (e.g., of input vectors with weights stored in the compute engine). Such tasks may be used in machine learning and/or other applications. In some embodiments, the compute engine includes a CIM module and an LU module. For example, FIG. 1 depicts a CIM module and an LU module. CIM module is a hardware module that stores data and performs operations. In some embodiments, CIM module stores weights for the model with which the system is used. The CIM module also performs operations using the weights. More specifically, the CIM module performs vector-matrix multiplications, where the vector may be an input vector provided using the processor and the matrix may be weights (e.g., data/parameters) stored by the CIM module. Thus, the CIM module may be considered to include a memory (e.g., that stores the weights) and compute hardware (e.g., that performs the vector-matrix multiplication of the stored weights). In some embodiments, the vector may be a matrix (e.g., an n×m vector where n>1 and m>1). For example, the CIM module may include an analog static random access memory (SRAM) having multiple SRAM cells and configured to provide output(s) (e.g., voltage(s)) corresponding to the data (weight/parameter) stored in each cell of the SRAM multiplied by a corresponding element of the input vector. In some embodiments the CIM module may include a digital static SRAM having multiple SRAM cells and configured to provide output(s) corresponding to the data (weight/parameter) stored in each cell of the digital SRAM multiplied by a corresponding element of the input vector. In some embodiments, the CIM module may include an analog resistive random access memory (RAM) configured to provide output (e.g., voltage(s)) corresponding to the impedance of each cell multiplied by the corresponding element of the input vector. Other configurations of the CIM module are possible. Each CIM module can thus store weights corresponding to a matrix in its cells and is configured to perform a vector-matrix multiplication of the matrix with an input vector.

In certain AI applications, the system is required to stream numerous weights to the AI accelerator or memory protection unit (MPU). For example, large language models (LLMs) implement a significant number of weights (e.g., parameters). LLMs can have on the order of billions of weights, which can translate to gigabytes of data that is to be loaded to the respective compute engines. AI accelerators can be implemented to process workloads for LLMs, however, AI accelerators according to related art systems cannot store all the weights locally at the AI accelerator. Accordingly, weights (e.g., a subset of the weights used by the LLM) are loaded onto the AI accelerator as they are needed. Because certain AI applications have a lot of weights that are to be loaded, related art systems encounter memory bounds.

Related art systems implement certain local memory to store weights that are to be loaded onto the AI accelerators as needed. Examples of local memory include DRAM, DDR, eDRAM. These types of local storage that related art systems implement for local memory are slow and serve as a bottleneck for the AI accelerator.

Various embodiments provide a system that can load data from memory to the accelerator in a manner that is sufficiently quick to not serve as a bottleneck for the processing of the workload by the compute engines. In some embodiments, the system comprises a local memory (e.g., DRAM, DDR, eDRAM, etc.) that stores weights and a local cache to which certain subsets of weights are loaded and cached for quick transfer to the compute engines when the weights are to be used. The local cache may implement a memory technology that is quicker than conventional local memories. For example, the system may implement a stationary memory unit, such as a static random-access memory (SRAM), as the local cache. In some embodiments, the system comprises a plurality of local caches for a plurality of compute engines. For example, the system comprises one local cache for each compute engine. In other embodiments, the system implements one local cache for a plurality of compute engines. For example, the system may comprise a single local cache that serves all compute engines (e.g., all compute engines on the compute tile).

In some embodiments, the system comprises a compute engine, a stationary memory unit, and a local memory coupled to the compute engine. The compute engine comprises a CIM module that can store weights to be used when processing a workload. In some embodiments, the stationary memory unit is deployed between the local memory and the CIM and the stationary memory unit is used as a cache for storing weights to be used in future cycles as the compute engine processes the desired workload.

In some embodiments, the system is implemented with an architecture that includes multi-channel local memory (e.g., eDRAM) connected to several stationary memory units (e.g., SRAMs), which in turn are directly connected to compute engines. The local memory (e.g., eDRAM) can also be connected to a direct memory access unit (DMA), SIMD unit, and a general-purpose processor (e.g., RISC-V) through a data bus (DB). The compute engines are connected to the single instruction multiple data arithmetic logic unit (SIMD) unit and the general-purpose processor (e.g., RISC-V) through a compute bus (CB). The SIMD unit may be used to accelerate particular functions such as activation functions, max pooling operations, softmax functions, and certain nonlinear operations.

The data such as stationary tensors (e.g., weights, parameters, etc.) are streamed from the local memory (e.g., eDRAM) to the stationary memory unit (e.g., S-SRAM), and then to the respective compute engines in time for when the compute engines are to use such weights in connection with processing the workload.

In some embodiments, the stationary memory unit (e.g., the S-SRAM) implemented as a local cache can be shared across multiple compute engines such as in case of limited DRAM channels.

The other tensors are steamed through the main SRAM (e.g., the SRAM coupled to the general-purpose processor), where quantization or other operations may be performed before vector-matrix multiplication (VMM), or DRAM if more memory is needed.

In some embodiments, the system uses the stationary memory units (e.g., the S-SRAM) to transpose the data before sending the data to the compute engine(s). For example, the transpose may be used for inference in some architectures such as MLP Mixers, training, or for attention layers in LLMs.

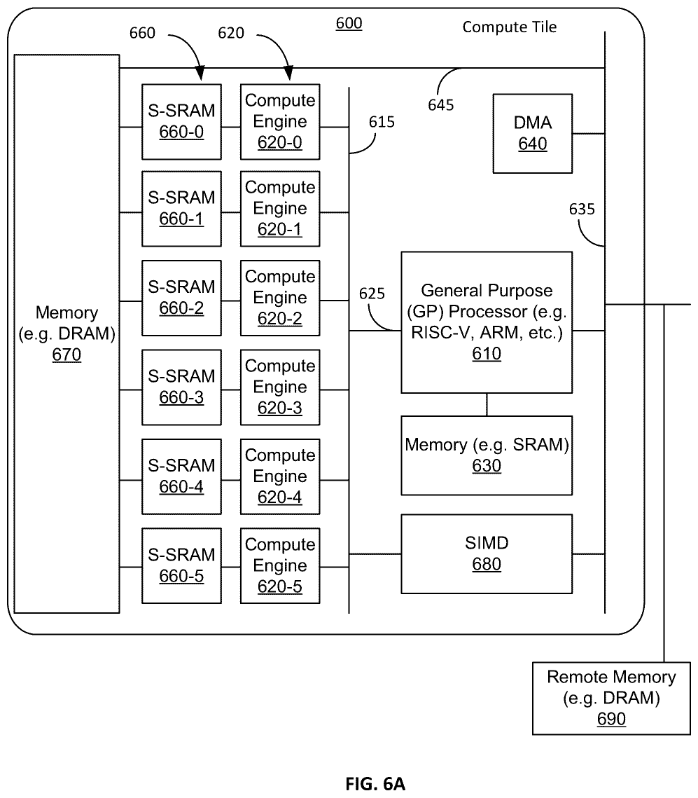

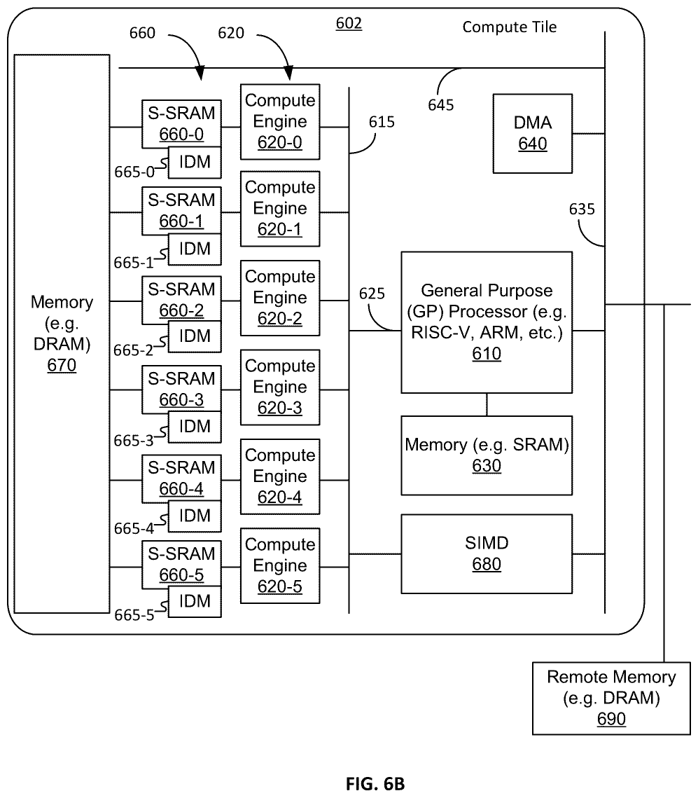

FIG. 6A is a diagram depicting a system usable in an accelerator for a learning network according to various embodiments. The system is a compute tile 600 and may be considered to be an artificial intelligence (AI) accelerator having an efficient architecture. Compute tile (or simply “tile”) 600 may be implemented as a single integrated circuit. Compute tile 600 includes a general purpose (GP) processor 610, compute engines 620-0 through 620-5 (collectively or generically compute engines 620), and stationary memory units 660-0 through 660-6 (collectively or generically stationary memory 660). In some embodiments, stationary memory 660 is directly connected to compute engines 620. Although five compute engines 620 are shown, in other embodiments another number may be included.

The number of compute engines 620 may be a design choice, such as based on optimizations along different dimensions. Because compute engines 620 share a common compute bus 615, increasing the number of compute engines 620 on a single compute tile 600 may introduce latency. In some embodiments, compute tile 600 comprises eight compute engines 620. In other embodiments, compute tile 600 comprises six compute engines 620. In some embodiments, compute tile 600 comprises less than ten compute engines 620.

GP processor 610 is shown as being coupled with compute engines 620 via compute bus 615 (or other connector), and bus 625. In other embodiments, GP processor 610 may be connected with compute engines 620 in another manner. For example, GP processor 610 may be wirelessly connected with compute engines 620. In some embodiments, compute tile 600 may include on-tile memory 630. In other embodiments, memory 630 may be omitted. Other components, for example a cache or another additional memory, module(s) for applying activation functions, modules for moving data, and/or other modules, may be present in compute tile 600 in some embodiments. In the example shown, compute tile 600 comprises SIMD unit 680, which may be configured to accelerate particular functions such as activation functions, max pooling operations, softmax functions, and/or certain nonlinear operations. SIMD unit 680 may be connected to compute engines 620 and/or GP processor 610 via compute bus 615. SIMD unit 680 may additionally be connected to GP processor 610 via data bus 635.

In some embodiments, GP processor 610 is a reduced instruction set computer (RISC) processor. For example, GP processor 610 may be a RISC-V processor or ARM processor. In other embodiments, different and/or additional general purpose processor(s) may be used. The GP processor 610 provides control instructions and data to the compute engines 620. GP processor 610 implements instruction set(s) used in controlling compute engines 620. GP processor 610 provides the commands to compute engines 620 and controls data movement to and/or from compute engines 620. GP processor 610 may thus function as part of a control plane for (e.g., providing commands and being part of the data path) compute engines 620 and compute tile 600.

In the example shown in FIG. 5, the compute engines 520 share a common compute bus 540. As a result, when the GP processor 510 causes weights to be loaded to the compute engines 520, the data is transferred over the common compute bus 540 to the respective compute engines 520. Accordingly, the use of the common compute bus 540 to load weights to the compute engine can introduce latency. As the number of compute engines deployed that are configured to share the compute bus 540 increases, the latency introduced by the sharing of the compute bus 540 may being to serve as a bottleneck for processing workloads. In some embodiments, compute tile 600 comprises compute engines 620 that are separately connected to the stationary memory units, which in turn can have separate connections to the local memory. In other embodiments, compute tile 600 comprises compute engines 620 configured so a smaller subset of compute engines share a connection to a stationary memory unit and/or local memory.

According to various embodiments, stationary memory 660 is configured to store data (e.g., weights or other parameters, etc.) that is to be loaded to compute engines 620, such as in connection with compute engines 620 performing VMMs. Stationary memory 660 can be implemented to serve as a local cache for compute engines 620. As an example, GP processor 610 may control data movement to and/or from stationary memory 660. Using the example shown in FIG. 6A, GP processor 610 may control moving (e.g., loading) data from memory 670 to stationary memory 660, for example, to cache the data in anticipation of the data to be subsequently loaded to compute engines 620. Additionally, or alternatively, GP processor 610 may control moving data from stationary memory to compute engines 620.

In the example shown, compute tile 600 comprises six stationary memory units 660-0 through 660-5. However, another number of stationary memory units may be implemented. In some embodiments, compute tile 600 comprises one stationary memory unit for each compute engine. In some embodiments, all compute engines 620 on compute tile 600 share a same stationary memory unit. In other embodiments, a subset of compute engines 620 share a single stationary memory unit (e.g., different subsets of compute engines 620 can have different common/shared stationary memory units).

In some embodiments, data is moved from memory 630 or another source to compute engine(s) 620 through GP processor 610. Data may be sent from memory 630 to internal memory of GP processor 610, and then to the appropriate compute engine(s) 620 via buses 615 and 625. For example, data from memory 630 may be provided to a vector register file (not shown) of GP processor 610 and then provided from GP processor 610 to the appropriate compute engine(s) 620. Once compute engines 620 have performed their functions, the output is provided to GP processor 610. Similarly, data may be moved from compute engines 620 to memory 630 or another destination via GP processor 610. Thus, GP processor 610 may be part of both the control plane and data plane for compute tile 600.

In some embodiments, data is moved from memory 670 to compute engines 620. The data can be moved from memory 670 to compute engines 620 via stationary memory 660. The data can be loaded to stationary memory 660 in advance of the data being needed by compute engines 620, cached at stationary memory 660, and then directly transferred/provided to compute engines 620 from stationary memory 660. Additionally, or alternatively, the data can be moved from memory 670 to compute engines 620 via GP processor 610, such as via data bus 635, bus 625, and compute bus 615. Once compute engines 620 have performed their functions, the output is provided to GP processor 610, such as via compute bus 615 and bus 625. Similarly, data may be moved from compute engines 620 to memory 630 or another destination via GP processor 610.

GP processor 610 may also perform other functions. GP processor 610 may apply activation function(s) to data. For example, an activation function (e.g., a ReLu, Tanh, and/or SoftMax) may be applied to the output of compute engine(s) 620. Thus, GP processor 610 may perform nonlinear operations. GP processor 610 may also perform linear functions and/or other operations. However, GP processor 610 is still desired to have reduced functionality as compared to, for example, a graphics processing unit (GPU) or central processing unit (CPU) of a computer system with which compute tile 600 might be used.

Compute engines 620 are configured to perform, efficiently and in parallel, tasks that may be part of using (e.g., performing inferences) and/or training (e.g., performing inferences and/or updating weights) a model. Compute engines 620 are coupled with and receive commands and, in at least some embodiments, data from GP processor 610. Compute engines 620 are modules which perform vector-matrix multiplications (VMMs) in parallel. Thus, compute engines 620 perform linear operations. Each compute engine 620 includes a CIM hardware module (not specifically shown in FIG. 6). The CIM hardware module stores weights corresponding to a matrix and is configured to perform a VMM in parallel for the matrix. Compute engines 620 may also include LU module(s) (not specifically shown in FIG. 6). Such LU module(s) allow compute engines 620 to update weights stored in the CIM.

The CIM module is a hardware module that stores data and performs operations. In some embodiments, CIM module stores weights for the model. As such, the CIM module determines the maximum size of the model that can be handled by compute tile 600 (e.g., the maximum number of parameters, or weights). The CIM module stores the weights (or other data) in cells that are fully addressable. The CIM module also performs operations using the weights. More specifically, the CIM module performs VMMs, where the vector may be an input vector (e.g., an activation) provided using GP processor 610 and the matrix may be weights (e.g., data/parameters) stored by the CIM module. The CIM module may be considered to include a memory (e.g., that stores the weights) and compute hardware (e.g., that performs the vector-matrix multiplication of the stored weights). In some embodiments, the vector may be a matrix. The CIM module may include an analog SRAM having multiple SRAM cells and configured to provide output(s) (e.g., voltage(s)) corresponding to the data (weight/parameter) stored in each cell of the SRAM multiplied by a corresponding element of the input vector. In some embodiments, the CIM module may include a digital SRAM having multiple SRAM cells and configured to provide output(s) corresponding to the data (weight/parameter) stored in each cell of the digital SRAM multiplied by a corresponding element of the input vector. Other configurations of CIM modules are possible. Each CIM module thus stores weights corresponding to a matrix in its cells and is configured to perform a vector-matrix multiplication of the matrix with an input vector. In some embodiments, the CIM module of a compute engine 620 may be repurposed as memory, for example, if the compute engine utilization falls below a particular threshold (e.g., 70%-80%). For example, the CIM might store duplicate weights or vectors (e.g., activations) in such embodiments.

In order to facilitate on-chip learning, LU modules (not shown) may also be provided in compute engines 620. LU modules are coupled with the corresponding CIM modules. LU modules are used to update the weights (or other data) stored in the CIM modules. LU modules are considered local because LU modules are in proximity to CIM modules. For example, LU module(s) for a particular compute engine 620 may reside in the same integrated circuit as the CIM module(s) for compute engine 620. In some embodiments, the LU module is considered local because it is fabricated on the same substrate (e.g., the same silicon wafer) as the corresponding CIM module. In some embodiments, LU modules are also used in determining the weight updates. In other embodiments, a separate component may calculate the weight updates. For example, in addition to or in lieu of LU modules, the weight updates may be determined by GP processor 610, in software by other processor(s) not part of compute tile 600, by other hardware that is part of compute tile 600, by other hardware outside of compute tile 600, and/or some combination thereof.

Memory 630 may be or include a static random access memory (SRAM) and/or some other type of memory. Memory 630 is shown as coupled with GP processor 610. Stated differently, data movement between memory 630 and compute engines 620 may take place via GP processor 610. In some embodiments, memory 630 may be coupled to compute bus 615 (e.g., to compute engines 620). Memory 630 may store activations (e.g., input vectors provided to compute tile 600 and the resultant of activation functions applied to the output of compute engines 620). Memory 630 may also store weights. For example, memory 630 may contain a backup copy of the weights or different weights if the weights stored in compute engines 620 are desired to be changed. In some embodiments, memory 630 is organized into banks of cells (e.g., banks of SRAM cells). In such embodiments, specific banks of memory 630 may service specific one(s) of compute engines 620. In other embodiments, banks of memory 630 may service any compute engine 620.

Memory 670 may be or include one or more of DRAM, SDRAM, eDRAM (embedded DRAM), HBM, and DDRx, and/or some other type of memory. Compute tile 600 uses memory 670 to store a set of weights at least a subset of which are to be loaded to compute engines 620, such as via a caching mechanism at stationary memory 660, when compute engines 620 are expected to use the weights. Memory 670 may be coupled to compute engines 620 via stationary memory 660. In some embodiments, memory 670 is coupled to data bus 635. In some embodiments, memory 670 is organized into banks of cells (e.g., banks of DRAM cells, etc.). In such embodiments, specific banks of memory 670 may service specific one(s) of compute engines 620. In other embodiments, banks of memory 670 may service any compute engine 620. In other embodiments, specific banks of memory 670 may serve a subset of compute engines 620 (e.g., different compute engines 620 can served by a different bank of memory 670).

In operation, an input vector is provided to one or more of compute engines 620 by GP processor 610. The input vector is desired to be multiplied by the weights, which may have been previously stored in compute engine(s) 620, or which may be loaded to compute engine 620 from memory 670. In some embodiments, the weights are loaded to compute engines 620 from memory 670 via stationary memory 660. For example, stationary memory 660 caches at least a subset of weights in advance of compute engine 620 requiring the weights, and the at least the subset of weights can be loaded to compute engine 620 from stationary memory 660 when needed. An input vector may be provided to multiple compute engines 620 if the weight matrix and/or input vector have too many elements for a single compute engine. In some such embodiments, a portion of the input vector is provided to each of the multiple compute engines 620 (each of which stores a portion of the weights). In some embodiments, the input vector is provided from memory 630 to GP processor 610 and from GP processor 610 to compute engine(s) 620. GP processor 610 also instructs compute engine(s) 620 to perform a VMM. Compute engine(s) 620 perform a VMM between the input vector and the matrix of weights to provide an output. The VMM is performed in parallel for the elements of the input vector. The output of compute engine(s) 620 may be considered an output vector. The output is provided by compute engine(s) 620 to GP processor 610. For example, the output may be stored in a vector register file of GP processor 610. GP processor 510 may also store the output (e.g., in memory 630) and/or may provide the output to another component off-tile. GP processor 610 may apply a function (e.g., an activation function) to the output. The results of the activation function applied to the output of compute engines 620 may be stored in GP processor 610 (e.g., in a buffer or the vector register file). GP processor 610 may also store the results in memory 630 or off-tile. GP processor 610 may provide the results as an input vector to other compute engine(s) 620 to apply a different set of weights to the results where another set of weights are stored in other compute engine(s) 620. Thus, one or more inferences with one or more distinct sets of weights may be performed. In some embodiments, training may also be performed by compute tile 600. In some such embodiments, GP processor 610 or another component (such as a host) may determine the desired update for the weights. In some embodiments, LU module (not shown) of compute engines 620 may be used to determine and apply the updates to the weights.

Also shown in FIG. 6 is remote memory 690. For example, remote memory 690 may include or be DRAM memory. Remote memory 690 may be used for long term storage. For example, input activations for training, target outputs for training, and/or other information may be stored in DRAM (e.g., remote memory 690). This information may be loaded into compute tile 600 as desired. For example, if compute tile 600 includes insufficient memory for performing a training iteration as part of a method for processing workloads, activations and/or other data may be temporarily stored and loaded from remote memory 690 (e.g., DRAM) during a training iteration.

Thus, compute tile 600 includes two compute blocks, GP processor 610 and compute engines 620, which work together. GP processor 610 may perform nonlinear operations (e.g., activation functions) and compute engines perform 620 may perform linear operations (e.g., VMMs). GP processor 610 is in the control and data planes for compute engines 620. GP processor 610 and compute engines 620 are, therefore, tightly coupled. Consequently, data may be moved more efficiently within compute tile 600. Operations, such as VMMs and the application of activation functions to the output of compute engines 620, may be more efficiently performed. Further, a special purpose controller need not be designed and fabricated for compute tile 600. Instead, GP processor 610 is used. As a result, compute tile 600 may be more flexible and more readily designed and fabricated. For example, the activation applied by GP processor 610 may be updated by updating GP processor 610. A new special purpose controller need not be provided. Consequently, functions for machine learning may be more efficiently and readily performed. In addition, compute tile 600 includes on-tile memory 630. Use of on-tile memory, for example as a scratchpad memory, allows for a high degree of independence of compute tile 600 from other components (e.g., other tiles). Thus, multiple compute tiles 600 may more readily work in parallel (e.g., as shown in FIGS. 11 and 12). Consequently, efficiency of learning may be enhanced.

In some embodiments, compute tile 600 (e.g., GP processor 610) determines when to load data from memory 670 to stationary memory 660 based on a difference in data transfer speed, for example, the speed at which data can be loaded from memory 670 to stationary memory 660 compared with the speed at which data can be loaded from stationary memory 660 to compute engines 620. Stationary memory 660 can be used to store (e.g., cache) data (e.g., weights or other parameters) to be used by compute engines 620 in a later cycle. As an illustrative example, if transfer from the DRAM (e.g., memory 670) to stationary memory 660 (e.g., SRAM) is ten times slower than the transfer of data from stationary memory 660 to compute engines 620, then compute tile 600 (e.g., GP processor 610) can control to move the data from the DRAM to stationary memory 660 well in advance of the compute engines 620 needing the data.

In the example shown, different stationary memory units of stationary memory 660 are connected to different compute engines 620. Thus, compute tile 600 (e.g., GP processor 610) can load a plurality of the compute engines 620 in parallel, which can reduce the amount of time required to fully load data to compute engines 620.

FIG. 6B is a diagram depicting a system usable in an accelerator for a learning network according to various embodiments. In the example shown, compute tile 602 is similar to compute tile 600 of FIG. 6A, except that compute tile 602 additionally comprises specific intelligent caching hardware mechanisms, for example, IDM unit 665-0 through IDM unit 665-5 (collectively, IDM hardware). Although five IDM units are shown, in other embodiments, another number may be included. For example, compute tile 602 comprises a different IDM unit for each stationary memory unit in stationary memory 660 (e.g., IDM unit 665-0 is a companion to stationary memory unit 660-0, IDM unit 665-3 is a companion to stationary memory unit 660-3, etc.). In other embodiments, compute tile 600 may comprise a single IDM unit that serves all stationary memory units in stationary memory 660. In other embodiments, compute tile 600 may comprise different IDM units that serves different subsets of stationary memory units of stationary memory 660.

There are multiple ways that the stationary memory 660 (e.g., the SRAM cache) could be used. For example, in some embodiments, the stationary memory 660 may be used with user-defined instruction. As another example, in some embodiments, the stationary memory 660 may be used with scram intelligent caching mechanisms.

For user-defined instructions, like static compilation, the compiler (not shown) would include data movement instructions at correct times in the exaction to move data from memory 670 (e.g., the DRAM) to the stationary memory 660 (e.g., to each CE's associated SRAM). This data management technique can be time consuming to design and increases complexity of the software stack associated with implementing the compute tile. Most related art systems use this technique in AI accelerators with “scratchpad” memories.

For intelligent caching mechanisms, the system (e.g., compute tile 602) may include an intelligent hardware (e.g., the IDM hardware) that implements an intelligent caching mechanism that detects the type of data accessed, the particular phase the execution (e.g., by the CE) is in. According to various embodiments, the IDM hardware automatically prefetches the rest of the desired data. This may be implemented with the help compiler cues to signal the prefetch and caching unit about specifics of the execution.

In some embodiments, intelligent caching mechanism is implemented based on a direct analysis of how execution and data accesses behave during the execution. In some cases, this mechanism can be a copy of the common prefetch and caching methods (e.g., strided, Markov, etc.). In other cases, this mechanism is more specific to AI workloads, which may implement larger prefetch granularity, larger cache lines, or less explored algorithms.

In some embodiments, the intelligent caching mechanism performs the caching based on its knowledge of the model being implemented. As an example, for a particular neural network, the system has a graph indicating the order of operations to be implemented when processing the workload. Accordingly, the system (e.g., the IDM hardware) knows certain sequences and/or times when the data is to be preprocessed (e.g., in the stationary memory 660) or preloaded to stationary memory 660. For example, the sequence or timing for loading data from DRAM to SRAM and from SRAM to CE can be defined based at least in part on the graph for the particular model being implemented. In AI applications, the graph of the order of operations is well-defined.

In some embodiments, IDM hardware may be added to the main stationary memory 660 (or directly coupled to the particular stationary memory unit). In some embodiments, the IDM is directly coupled to the GP processor 610. However, it may be desirable for the memory 630 to be managed by GP processor 610. In a scalable architecture design, the stationary memory 660 (e.g., stationary memory units 660- through 660-5) may be hidden from other units unless for certain operations (e.g., similar to hardware-managed caches that are hidden unless for line eviction).

Although the compute tiles 600 and 602 are shown as a planar where there the constituent units/modules are co-planar, in some embodiments, a stacked architecture may be used. A stacked architecture may be implemented in cases where larger memory (e.g., the DRAM and/or SRAM) is desired. Additionally, or alternatively, a stacked architecture may be implemented in cases where the x-y real estate of the compute tile is restricted.

In some embodiments, the stacked architecture of the compute tile has two layers. For example, the compute tile comprises a base layer and a memory layer. The compute layer comprises the GP processor (e.g., an RISC-V processor, ARM processor, etc.), the compute engines (e.g., compute engines 620), and the stationary memory (e.g., stationary memory 660) such as SRAM memory. The memory layer includes the DRAM memory (e.g., memory 670) from which the weights are loaded to the stationary memory.

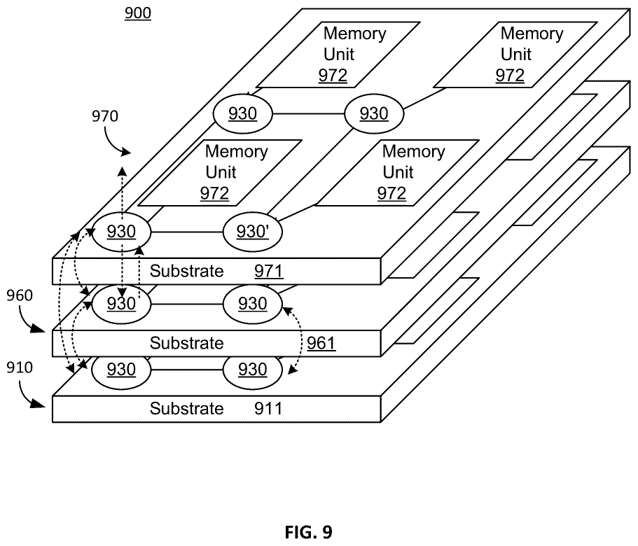

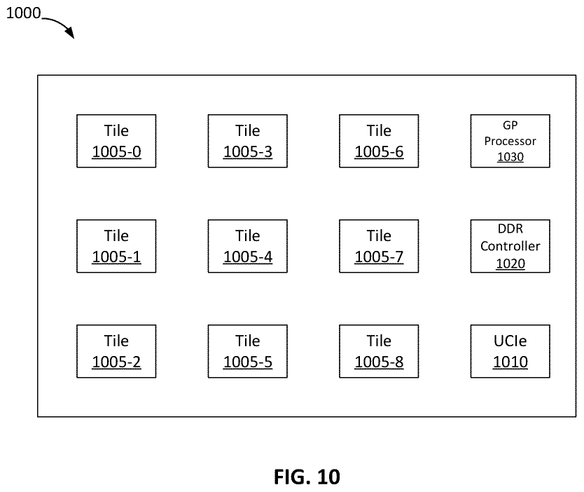

According to various embodiments, the various layers within the stacked architecture can be integrated through a Through-Silicon-Visa (TSVs) or a through coupling Interface (TCI), which is further described in FIGS. 9 and 10.

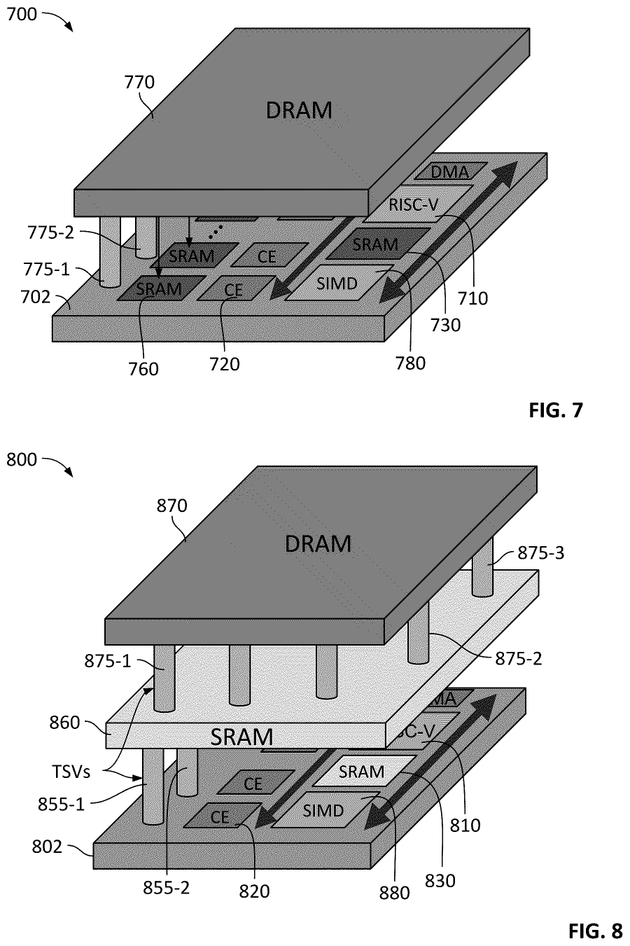

FIG. 7 is a diagram depicting a vertically integrated system usable in an accelerator for a learning network according to various embodiments. FIG. 7 shows an architecture for the compute-near memory (e.g., local DRAM) with a stacked memory (e.g., DRAM, DDR, HBM, etc.) on top of the CIM architecture. Each compute tile can have a direct connection to a memory block (e.g., a DRAM block) which could include or consist of multiple banks. For example, each DRAM bank is directly connected (e.g., coupled) to the CIM layer.

In the example shown, system 700 (e.g., an IC) comprises a two-layer stacked architecture (e.g., a stacked CIM-DRAM architecture). System 700 comprises compute layer 702 and memory layer 770. In some embodiments, compute layer 702 corresponds to compute tile 600 or compute tile 602 without memory 670 (e.g., which corresponds memory layer 770). In the example shown, compute layer 702 comprises GP processor 710, memory 730, compute engines 720, and stationary memory 760. Compute layer 702 may additionally comprise SIMD unit 780. According to various embodiments, GP processor 710 functions similar to GP processor 610 of FIGS. 6A and 6B; memory 730 functions similar to memory 630 of FIGS. 6A and 6B; compute engines 720 function similar to compute engines 620 of FIGS. 6A and 6B; stationary memory 760 functions similar to stationary memory 660 of FIGS. 6A and 6B; and/or SIMD unit 780 functions similar to SIMD unit 680.

In some embodiments, memory layer 770 comprises includes the memory (e.g., DRAM, DDR, HBM, etc.) from which the weights are loaded to the stationary memory 760 (e.g., for caching). Memory layer 770 may comprise a single block of memory or a bank of memory blocks.

The memory layer 770 can be integrated with the tile in a 3D stacked architecture integrated through Through-Silicon-Visa (TSVs) or Through coupling Interface (TCI). For example, each memory bank may have one/multiple channels for high bandwidth thereby leading to the use of multiple TSVs or TCIs depending on the bandwidth and data rate. According to various embodiments, in order to increase the data rate/bandwidth, serializer-deserializer circuits may be implemented to reduce the number of physical connections while keeping a high data rate.

In the example shown, memory layer 770 is coupled to compute layer 702 via a plurality of TSVs. For example, TSV 775-1 and TSV 775-2 connect memory layer 770 and compute layer 702 and can serve as the channels over which data is communicated from memory layer 770 (e.g., memory 670 of FIGS. 6A and 6B) to the stationary memory 760. Although the example shows two TSVs coupling memory layer 770 and compute layer 702, various numbers of TSVs may be implemented.

According to various embodiments, to further benefit stacking in more heterogeneous 3D architecture, layers of stationary memory (e.g., SRAM) may be stacked between memory (e.g., DRAM, DDR, HBM) to function as large caches while keeping the logic and few SRAMs next to the logic, as shown in FIG. 8. In other embodiments, only DRAM or only SRAM may have the stacked architecture. Although indicated as SRAM in the following figures, in some embodiments, SSRAM is present and may have a stacked architecture.

FIG. 8 is a diagram depicting a vertically integrated system usable in an accelerator for a learning network according to various embodiments. FIG. 8 shows an architecture for the compute-near memory (e.g., local DRAM) with a stacked memory (e.g., DRAM, DDR, HBM, etc.) and a stacked stationary memory (e.g., SRAM) on top of the CIM architecture. Each compute tile can have a direct connection to a memory block (e.g., a DRAM block) which could include or consist of multiple banks. For example, each DRAM bank is directly connected (e.g., coupled) to the CIM layer. Similarly, each compute tile can have a direct connection to a stationary memory block (e.g., an SRAM block) which could include or consist of multiple banks.

In the example shown, system 800 (e.g., an IC) comprises a three-layer stacked architecture (e.g., a stacked CIM-SRAM-DRAM architecture). However, additional layers of memory may be stacked. System 800 comprises compute layer 802, stationary memory layer 860, and memory layer 870. In some embodiments, compute layer 802 corresponds to compute tile 600 or compute tile 602 without memory 670 (e.g., which is implemented at memory layer 770) and stationary memory 660 (e.g., which is implemented at stationary memory layer 860). In the example shown, compute layer 802 comprises GP processor 810, memory 830, and compute engines 820. Compute layer 802 may additionally comprise SIMD unit 880. According to various embodiments, GP processor 810 functions similar to GP processor 610 of FIGS. 6A and 6B; memory 830 functions similar to memory 630 of FIGS. 6A and 6B; compute engines 820 function similar to compute engines 620 of FIGS. 6A and 6B; and/or SIMD unit 880 functions similar to SIMD unit 680.

In some embodiments, memory layer 870 comprises the memory (e.g., DRAM, DDR, HBM, etc.) from which the weights are loaded to the stationary memory 860 (e.g., for caching). Memory layer 870 may comprise a single block of memory or a bank of memory blocks.

Although shown as monolithic blocks, the DRAM (e.g., for memory layer 770 of FIG. 7 or memory layer 870 of FIG. 8) and SRAM (e.g., for stationary memory layer 860 of FIG. 8) for the tiles may be individual stacked DRAM (or other type of memory) and/or SRAM modules analogous to those shown for an architecture that is not stacked.

In some embodiments, intelligent caching hardware mechanisms can be implemented in the stacked architectures. For example, the compute layers or stationary memory layers may comprise the appropriate IDM hardware.

FIG. 9 is a diagram depicting a vertically integrated system usable in an accelerator for a learning network according to various embodiments. Computing device 900 is analogous to computing systems illustrated in FIGS. 1-8, and particularly the systems shown in FIGS. 6A, 6B, 7, 8, and 9. Computing device 900 includes three layers 970, 960, and 910 (collectively or generically the architecture layer(s)) that are analogous to memory layer 870, stationary memory layer 860, and compute layer 802 of FIG. 8. Each architecture layer (e.g., layer 970, 960, and 910, etc.) includes routers 930 on its respective substrate (e.g., substrate 971 for memory layer 970, substrate 961 for stationary memory layer 960, and substrate 911 for compute layer 910). The architecture layers in computing device 900 may have a different number of routers 930. Computing device 900 may be implemented as a single, vertically scaled IC. Further, communication between layers via routers 930 is shown by dashed two-headed arrows for routers 930 near the edges of the substrates (e.g., substrates 911, 961, and 971). In some embodiments, other routers 930 in the architecture layers may also communicate vertically. However, for clarity, dashed two-headed arrows are not shown for these other routers 930.

In computing device 900, memory layer 970 explicitly includes router 930′ that does not transmit or receive data from other the layers (e.g., compute layer 910 and stationary memory layer 960). Thus, in some embodiments, not all routers 930 perform wireless transmission or reception of data.

Routers 930 interconnect units in a layer. In system 1000, routers 930 on compute layer 910 allow each compute unit to communicate with all other compute units in compute layer 910. Thus, routers 930 provide for horizontal routing of data between compute units on the same layer. For the horizontal routing of data in a layer (e.g., compute layer 910), router 930 may be configured as a switch. In other embodiments, routers 930 only allow for communication between a particular unit (e.g., a particular compute unit) and a portion of the remaining units (e.g., compute units) on the same layer.

In addition to horizontal routing, at least some routers 930 provide for vertical communication between architecture layers. For example, a router 930 disposed on memory layer 970 may be configured to communicate with a router on stationary memory layer 960 and/or compute layer 910. In computing device 900, all routers 930 perform both horizontal routing (e.g., transfer of information between units in the same architecture layer) and vertical routing (e.g., transfer of information between architecture layers). In other embodiments, only a portion of routers 930 perform vertical communication. In such embodiments, information to be transmitted vertically may first be transferred horizontally in a particular architecture layer to the particular router(s) 930 that are capable of transmitting information vertically, and then transmitted by the particular router(s) 930 to another architecture layer. The communication between layers by routers 930 is indicated by dashed arrows in FIG. 9.

Routers 930 in one architecture layer are inductively coupled to routers in another architecture layer. For example, a router 930 in memory layer 970 is inductively coupled to a router 930 in stationary memory layer 960). Thus, routers 930 can be used to transfer information wirelessly between layers using inductive coupling. Stated differently, routers 930 in one architecture layer may broadcast data to other architecture layer(s). In some embodiments, information is transferred between adjacent layers. For example, router(s) 930 in memory layer 970 may send information to router(s) 930 in stationary memory layer 960 and vice versa. In some embodiments, information may also be transferred between non-adjacent layers. For example, router(s) 930 in compute layer 910 may transmit information to router(s) 930 in memory layer 970, and vice versa. For example, routers 930 in compute layer 910 may transmit information from a general processor or other processing unit on compute layer 910 that orchestrates the caching of information from memory layer 970 to a stationary memory unit in stationary memory layer 960. In some embodiments, information may be transferred to an architecture layer (not shown) that is two architecture layers or more away from the architecture layer of the source router. Transmission between non-adjacent architecture layers may be possible because the transfer of information is performed wirelessly and, in some embodiments, through the inductive coupling between routers 930. Thus, three-dimensional mesh routing may be used such that each architecture layer can communicate vertically with any other layer. In some embodiments, different frequencies of transmission/reception or other modulation may be used for particular layers.

Computing device 900 may operate in an analogous manner to and shares the benefits of system 800. Weights or other data may be transferred wirelessly between layers using routers 330. As a result, latency and power consumed may be reduced for computing device 900. Moreover, wireless transmission of information between architecture layers may have a high bandwidth. Consequently, latency may be further improved. Because computing device 900 is integrated vertically, the area consumed by computing device 900 may be reduced. Computing device 900 may, therefore, have superior performance and scalability. Fabrication of computing device 900 may also be facilitated because alignment tolerances may be increased. Although discussed in the context of benefits for AI accelerators, computing device 900 may have improved performance when used for other applications.

In some embodiments, the use of wireless communication between layers in the architecture allows for communication to flow between layers even if any two layers are somewhat misaligned from. Wireless transmission of information between the architecture layers is still possible because the inductive coupling between routers 930 has a wider range than, for example, wired coupling using through silicon vias (TSVs) or other similar technology. Thus, fabrication of computing device 900 may be facilitated.

Wireless coupling between layers (e.g., between units on different layers) and the wireless transmission of information between layers is further described in U.S. Pat. No. 12,159,683, the entirety of which is hereby incorporated herein for all purposes.

FIG. 10 is a diagram depicting a system usable in an accelerator for a learning network according to various embodiments. According to various embodiments, the architecture described herein (e.g., the compute tile(s) depicted in FIGS. 5, 6A, and 6B, and/or the systems or ICs depicted in FIGS. 7 and 8) may be integrated into a larger system-on-a-chip (SoC)/network-on-a-chip (NoC). In some embodiments, this is accomplished via a 2D mesh, where each tile may operate as an independent unit with dedicated compute, memory, and I/O.

In the example shown, system 1000 comprises a set of compute tiles, such as compute tiles 1005-0 through 1005-8. In some embodiments, one or more of the compute tiles in the set of compute tiles corresponds to compute tile 600 of FIG. 6A, compute tile 602 of FIG. 6B, system 700 of FIG. 7, and/or system 800 of FIG. 8.

System 1000 (e.g., the NoC) may configure the compute tiles in various topologies, including but not limited to mesh, tree, and ring, for application-specific optimizations. System 1000 may be configured to facilitate efficient all-to-all connectivity between the tiles, casting (unicast and multicast) activations and/or partial sums throughout the architecture for efficient computing on large matrices.

In some embodiments, system 1000 further comprises a general purpose processor (e.g., GP processor 1030). GP processor 1030 may be implemented as an RISC-V processor, an ARM processor, etc. GP processor 1030 may be included in system 1000 to run scheduling, pre-processing, post-processing, I/O management, and/or a full operating system. System 1000 may comprise standard I/O interfaces, such as PCIe, USB, and/or CSI (e.g., for direct connection to sensors), etc.

In some embodiments, system 1000 comprises DDR controller 1020. DDR controller 1020 can be used to move the data from the main DRAM off the chip (e.g., DDRx) to the tile DRAM (e.g., the DRAM located on a particular compute tile). In some embodiments, DDR controller 1020 has access to all DRAMs across the chip (e.g., across the compute tiles in system 1000). In some embodiments, in a 3D stacked architecture such as the architectures illustrated in FIGS. 7 and 8, DDR controller 1020 may have direct access to the stacked memory layers (e.g., the DRAMs layers used to load weights into stationary memory units as a cache for the compute engines), thereby improving the parallelism of the chip.

In some embodiments, system 1000 may also utilize advanced die-to-die interconnects, such as UCle 1010, for high-speed chiplet connectivity. The internal die-to-die module may connected to the general purpose processor. For example, UCle 1010 can be connected to GP processor 1030. With support for die-to-die connectivity, each chiplet may connect to other chiplets on the same board, a host CPU on the same board that supports die-to-die connection, or other chiplets on the same board that support die-to-die connection. Chiplets may be arranged in various topologies, such as mesh, tree, and ring.

According to various embodiments, in addition to the DRAM modules in each tile, the architecture may contain a shared DRAM module across all in-memory compute tiles. For HBM (high bandwidth memory) support, the chiplet is fabricated using chip-on-wafer-on-substrate packaging, where the proposed SoC connects to the HBM dies through a silicon interposer, as illustrated in FIGS. 11 and 12.

According to various embodiments, the architecture described herein (e.g., as depicted, for example, in FIGS. 6A, 6B, 7, and 8) is implemented through chipset technology. The implementation using chipset technology may be beneficial for high compute-intensive and/or storage-intensive applications, for example in data centers. The implementation of the architecture using chipset technology may use UCIe as a communication protocol or other suitable protocol. To achieve a higher compute and storage density, while maintaining a good balance between compute capability per effective bandwidth, 2.5D or 3.5D architectures may be used. Such architectures may be achieved by chiplet integrations, interposers, UCIe communication protocols, and/or other techniques. For example, supporting interposer connectivity in the CIM architecture may allow HBM integration with CIM arrays.

FIG. 11 is a diagram depicting a 2.5D integrated circuit (IC) system usable in an accelerator for a learning network according to various embodiments. In the example shown, system 1100 comprises interposer 1110 that supports a plurality of chiplets. For example, system 1100 comprises a control chiplet 1120 and one or more accelerator chiplets (e.g., accelerator chiplet 1130, chiplet 1140, etc.) supported by interposer 1110. System 1100 may additionally comprise a memory chiplet 1150. The various chiplets supported by interposer 1110 can be connected via bus 1102 and can communicate using a high-bandwidth communication protocol, such as UCIe.

In some embodiments, the accelerator chiplets may be implemented as a SoC or NoC, such as using the architecture depicted in FIG. 10. The compute tiles in the accelerator chiplets may implement the architecture described in connection with FIGS. 5, 6A, and/or 6B. In the case that the accelerator chiplet implements an architecture similar to compute tile 600 or compute tile 602, because system 1100 may have a memory chiplet 1150, the accelerator chiplets may not require the local memory used to load weights or data to the stationary memory unit(s) serving as a cache(s) for the compute engines. For example, the accelerator chiplet implements an architecture such as a compute tile 600 without memory 670, and the accelerator chiplet uses memory chiplet 1150 in place of the memory 670.

Memory chiplet 1150 may be a block of memory or banks of memory cells. Memory chiplet 1150 may be or include one or more of DRAM, SDRAM, eDRAM (embedded DRAM), HBM, and DDRx, and/or some other type of memory.

According to various embodiments, control chiplet 1120 may be a processing unit that can be used to offload and accelerate specialized tasks, such as in a data center server or appliance. Control chiplet 1120 can be used to control and orchestrate the functioning of the various other chiplets comprised in system 1100 to process a workload. In some embodiments, control chiplet 1120 may be, or include, one or more of a CPU, a GPU, a data processing unit (DPU), a infrastructure processing unit (IPU), a function accelerator card (FAC), a network attached processing unit (NAPU), a field programmable gate array (FPGA), a vision processing unit (VPU), etc.

FIG. 12 is a diagram depicting a 3.5D integrated circuit (IC) system usable in an accelerator for a learning network according to various embodiments. According to various embodiments, the 3.5D architecture includes of multiple stacks of the 3D architecture described herein, for example, the architectures depicted in FIG. 7 or FIG. 8. In the example shown, system 1200 comprises interposer 1210 that supports a plurality of chiplets. For example, system 1200 comprises a control chiplet 1220 and one or more accelerator chiplets (e.g., accelerator chiplet 1230, chiplet 1240, etc.) supported by interposer 1210. System 1200 may additionally comprise a memory chiplet 1250. The various chiplets supported by interposer 1210 can be connected via bus 1202 and can communicate using a high-bandwidth communication protocol, such as UCIe.

In some embodiments, the accelerator chiplets may be implemented using the architectures shown and described in connection with FIGS. 7 and 8. In the example shown, accelerator chiplets 1230 and 1240 are similar to the architecture depicted in FIG. 8, for example, a three-layer stacked architecture (e.g., a stacked CIM-SRAM-DRAM architecture).

According to various embodiments, control chiplet 1220 may be a processing unit that can be used to offload and accelerate specialized tasks, such as in a data center server or appliance. Control chiplet 1220 can be used to control and orchestrate the functioning of the various other chiplets comprised in system 1100 to process a workload. In some embodiments, control chiplet 1220 may be, or include, one or more of a CPU, a GPU, a DPU, a IPU, a FAC, a NAPU, a FPGA, a VPU, etc.

Although shown as monolithic blocks, the memory (e.g., the DRAM and/or SRAM) for the tiles may be individual stacked memory modules (e.g., DRAM modules and/or SRAM modules).

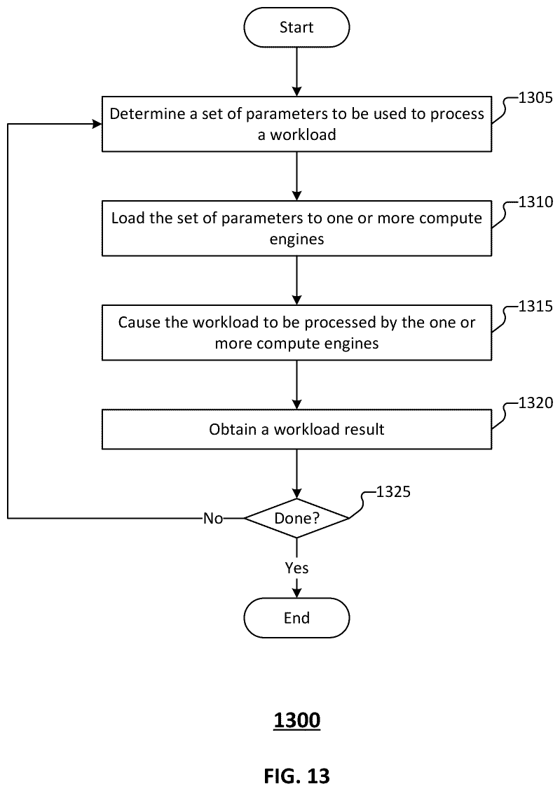

FIG. 13 is a flow diagram of a method for processing a workload by a system including a compute engine according to various embodiments. In some embodiments, process 1300 is implemented by a hardware accelerator IC. For example, process 1300 can be implemented by a control unit in the accelerator (e.g., an RSIV, etc.). As an illustrative example, process 1400 may be implemented by GP processor 610 in compute tile 600.

At 1305, the system determines a set of parameters to be used in a workload. At 1310, the system loads the set of parameters to one or more compute engines. At 1315, the system causes the workload to be processed by the one or more compute engines. At 1320, the system obtains a result. At 1325, the system determines whether process 1300 is complete. In some embodiments, process 1300 is determined to be complete in response to a determination that no further workloads are to be processed, processing of the workload is complete, an administrator indicates that process 1300 is to be paused or stopped, etc. In response to a determination that process 1300 is complete, process 1300 ends. In response to a determination that process 1300 is not complete, process 1300 returns to 1305.

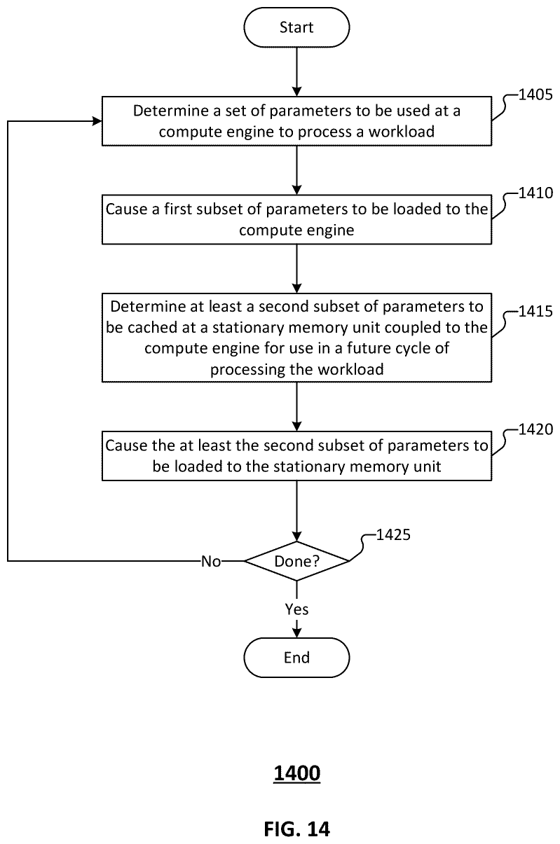

FIG. 14 is a flow diagram of a method for loading parameters on a compute engine for processing a workload according to various embodiments. In some embodiments, process 1400 is implemented by a hardware accelerator IC. For example, process 1400 can be implemented by a control unit in the accelerator (e.g., an RSIV, etc.). As an illustrative example, process 1400 may be implemented by GP processor 610 in compute tile 600.

At 1405, the system determines a set of parameters to be used at a compute engine to process a workload. At 1410, the system causes a first subset of parameters to be loaded to the compute engine. At 1415, the system determines at least a second subset of parameters to be cached at a stationary memory unit coupled to the compute engine for use in a future cycle of processing the workload. At 1420, the system causes the at least the second subset of parameters to be loaded to the stationary memory unit. At 1425, the system determines whether process 1400 is complete. In some embodiments, process 1400 is determined to be complete in response to a determination that no further workloads are to be processed, processing of the workload is complete, an administrator indicates that process 1400 is to be paused or stopped, etc. In response to a determination that process 1400 is complete, process 1400 ends. In response to a determination that process 1400 is not complete, process 1400 returns to 1405.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A hardware accelerator tile, comprising:
a plurality of compute engines respectively including compute-in-memory (CIM) modules configured to perform, in parallel, vector matrix multiplications (VMMs) on stored parameters;
one or more stationary memory units coupled with the plurality of compute engines; and
local memory coupled with the plurality of compute engines.

2. The hardware accelerator tile of claim 1, wherein data is loadable to the plurality of compute engines from the local memory or from the stationary memory units.

3. The hardware accelerator tile of claim 2, wherein the data loadable from the local memory or the stationary memory units comprises the parameters used in connection with the VMMs.

4. The hardware accelerator tile of claim 1, wherein the local memory is a static random-access memory (SRAM).

5. The hardware accelerator tile of claim 1, wherein a particular stationary memory unit of the one or more stationary memory units comprises a static random-access memory (SRAM).

6. The hardware accelerator tile of claim 1, wherein:
a set of parameters is loaded to a particular compute engine directly from a corresponding stationary memory unit;
the particular compute engine is comprised in the plurality of compute engines; and
the corresponding stationary memory unit is comprised in the one or more stationary memory units.

7. The hardware accelerator tile of claim 6, wherein the corresponding stationary memory unit is connected directly to the particular compute engine.

8. The hardware accelerator tile of claim 1, wherein data is provided from a memory to at least one stationary memory unit of the one or more stationary memory units.

9. The hardware accelerator tile of claim 8, wherein a time for loading the data from the memory to the at least one stationary memory unit is longer than a time for loading the data from the at least one stationary memory unit to the corresponding at least one compute engine.

10. The hardware accelerator tile of claim 8, wherein the memory is a dynamic random-access memory (DRAM), a double data rate (DDR), or a high bandwidth memory (HBM).

11. The hardware accelerator tile of claim 1, wherein the one or more stationary memory units are used as a cache for a set of parameters that is to be loaded to the plurality of compute engines.

12. The hardware accelerator tile of claim 1, wherein the one or more stationary memory units are vertically integrated with the plurality of compute engines.

13. The hardware accelerator tile of claim 1, further comprising a memory that stores a set of parameters to be loaded to the plurality of compute engines.

14. The hardware accelerator tile of claim 15, wherein at least a subset of the set of parameters are cached in the one or more stationary memory units.

15. The hardware accelerator tile of claim 14, wherein two of the plurality of layers communicate wirelessly.

16. The hardware accelerator tile of claim 14, wherein the hardware accelerator is one tile among a plurality of tiles in a chip architecture.

17. A machine learning system, comprising:
at least one processor; and
a plurality of tiles coupled with the at least one processor, each of the plurality of tiles including: (i) a plurality of compute engines respectively including compute-in-memory (CIM) modules configured to perform, in parallel, vector matrix multiplications (VMMs) on stored parameters, (ii) one or more stationary memory units coupled with the plurality of compute engines, and (iii) local memory coupled with the plurality of compute engines.

18. The machine learning system of claim 17, wherein:
a set of parameters is loaded to a particular compute engine directly from a corresponding stationary memory unit;
the particular compute engine is comprised in the plurality of compute engines; and
the corresponding stationary memory unit is comprised in the one or more stationary memory units.

19. A method, comprising:
storing a set of parameters to be used in connection with vector matrix multiplications (VMMs);
loading a subset of the parameters to a particular stationary memory unit; and
loading the subset of parameters from the particular stationary memory unit to a particular compute engine,
wherein the particular compute engine and the particular stationary memory unit are comprised in a hardware accelerator tile comprising (i) a plurality of compute engines, (ii) one or more stationary memory units coupled with the plurality of compute engines, and (iii) local memory coupled with the plurality of compute engines.

20. The method of claim 19, wherein the subset of parameters are cached at the particular stationary memory unit before the particular compute engine is to use the subset of parameters in connection with the VMMs.
